(19) United States
(12) Patent Application Publication
(10) Pub. No.: US 2013/0182474 A1
(43) Pub. Date: Jul. 18, 2013

(54) POWER CONVERSION DEVICE FOR SOLAR ENERGY GENERATING SYSTEM

(71) Applicants: CHIA-CHING LUO, MIAOLI COUNTY (TW); WEI-SHENG CHANG, HSINCHU COUNTY (TW); TSUNG-HSIEN WU, HSINCHU COUNTY (TW); TE-CHENG LIU, HSINCHU COUNTY (TW)

(72) Inventors: CHIA-CHING LUO, MIAOLI COUNTY (TW); WEI-SHENG CHANG, HSINCHU COUNTY (TW); TSUNG-HSIEN WU, HSINCHU COUNTY (TW); TE-CHENG LIU, HSINCHU COUNTY (TW)

(73) Assignee: TOPPER SUN ENERGY TECHNOLOGY CO., LTD., MIAOLI COUNTY (TW)

(21) Appl. No.: 13/349,592

(22) Filed: Jan. 13, 2012

(51) Int. Cl. H02M 7/44

(52) U.S. Cl. 363/95

(57) ABSTRACT

A power conversion device includes a DC-DC converter, a DC-AC inverter and a relay. The DC-DC converter leads in a DC from an external solar panel and transforms the DC into a direct voltage. The DC-AC inverter transforms the direct voltage from the DC-DC converter into an alternating voltage and connecting to an external electric load via electric load output ends. The relay includes a coil connected to an external commercial power line via commercial power input ends, and conductive contacts actuated by the coil and serially-disposed between the commercial power input ends and the DC-AC inverter, and with the commercial power line electrifying the coils, the conduction control is formed therebetween, preventing the electric energy of the solar energy generation from inversely transmitting to the commercial power line when interrupting the commercial power service.

### BACKGROUND OF THE INVENTION

1. Field of the Invention

The present invention relates to a power conversion device for a solar energy generating system, and in particular relates to an inverter circuit device capable of preventing the electric energy generated from the solar energy generation from being inversely transmitted to the commercial power line (islanding effect) when the commercial power service is interrupted.

2. Description of the Related Art

As shown in FIG. 1, the basic structure of a conventional paralleled-type inverter 10 with solar energy generation is illustrated. The inverter 10 at least includes a direct current-to-direct current (DC-DC) converter 102 and a direct current-to-alternating current (DC-AC) inverter 103. The DC-DC converter 102 includes power input ends 101 capable of leading in a direct current which is generated from an external solar panel 4 (i.e., solar cell) when transforming the solar radiation energy. The (DC) output voltage direct current from the solar panel 4 can be changed by the DC-DC converter 102 and transformed into an alternating voltage via the DC-AC inverter 103, the alternating voltage from the DC-AC inverter 103 can be led out via power output ends 104 to supply electric energy to an external electric load 3, and therefore a solar energy power supply system can be formed. However, the solar panel 4 can generate the electric energy only when being radiated by sunshine. When a raining day (e.g., insufficient sunshine) or a dark night, the solar panel 4 cannot normally or continuously supply power. In practical applications of the solar energy power supply system, the inverter 10 is further connectively paralleled to an alternating current power of a commercial power line 2, so that the commercial power line 2 is able to supply electric energy to the electric load 3 once the inverter 10 (the solar energy power supply system) is unable to supply normal or sufficient power to the electric load 3. However, in the above-described structure, due to the inverter 10 being continuously connected to the commercial power line 2 without any connection cutoff mechanisms, the inverter 10 is still continued to supply power (in full-load) to the electric load 3 when the commercial power line 2 is malfunctioned or unable to supply electric energy, and therefore the electric energy supplied form the inverter 10 inversely impacts the facilities of the commercial power line 2 to result in a so-called islanding effect (possibly to endanger the facility maintenance personnel or constructers in the commercial power system).

In view of this, an inverter 1 of FIG. 2 is provided to prevent the islanding effect from happening. The inverter 1 includes a direct current-to-direct current (DC-DC) converter 12, a direct current-to-alternating current (DC-AC) inverter 13, input end filters 14 disposed ahead of the DC-DC converter 12 and having power input ends 141 connected to an external solar panel 4, and output end filters 15 disposed on output ends of the DC-AC inverter 13 and connectively paralleled to a commercial power line 2 and an electric load 3 via power output ends 151. A direct current generated from the transformed solar radiation energy from the solar panel 4 is led in the input end filter 14 via the power input ends 141 for filtering abnormal electric currents or impulse outputting therefrom and is transformed into a direct voltage via the DC-DC converter 12, and the direct voltage outputting from the DC-DC converter 12 is transformed into a desired alternating current power via the DC-AC inverter 13. Finally, a harmonic wave of the output current from the DC-AC inverter 13 is filtered via the output end filter 15. Further, the inverter 1 further includes a controller 16 and two sets of the relays 17 and 18 provided with coils 171 and 181, wherein the controller 16 is utilized to detect the power supply state of the commercial power line 2, the coils 171 and 181 of the two sets of the relays 17 and 18 controlled by the controller 16 are utilized to actuate two sets of normal close contacts 172 and 182 serially disposed between the DC-AC inverter 13 and the power output ends 151. In applications, when the commercial power line 2 detected by the controller 16 is in a normal power supply state, and the coils 171 and 181 of the two sets of the relays 17 and 18 are not allowed to be electrified, thereby remaining the two sets of normal close contacts 172 and 182 in a normal close conductive state to ensure the inverter 1 (the solar energy power supply system) with a normal output and preserving both the inverter 1 and the commercial power line 2 in a normal parallel power supply state. If the power supply output of the commercial power line 2 cannot be detected by the controller 16, i.e., the malfunctioned commercial power line 2 or power supply abnormality is occurred, the coils 171 and 181 of the two sets of the relays 17 and 18 are electrified by the controller 16 to actuate and present the two sets of normal close contacts 172 and 182 in an open (open-circuit) state (shown as dotted lines in FIG. 2), thereby terminating and preventing the output electric energy of the inverter 1 from inversely impacting the facilities of the commercial power line 2 when the commercial power service is interrupted. However, there is a serious flaw in this measure in that, even though the islanding effect can be effectively prevented, the power supply required by the electric load 3 is simultaneously interrupted, i.e., the electric load 3 cannot be normally operated.

### BRIEF SUMMARY OF THE INVENTION

In view of this, the present invent is submitted to overcome the difficulties in these conventional power conversion devices.

The purpose of the present invent is to provide a power conversion device for a solar energy generating system capable of immediately terminating the connection state of between the solar energy generating system and the commercial power line once the commercial power line is unable to supply electric energy, so that the electric energy from the solar energy generation can be prevented from inversely impacting to the commercial power line when the commercial power service is interrupted, i.e., the islanding effect can be effectively prevented.

Another purpose of the present invention is to provide a power conversion device for a solar energy generating system, which can be conveniently adopted and do not affect the normal power supply of the solar energy generating system to the electric load when the connection state of between the solar energy generating system and the commercial power line is terminated.

Still another purpose of the present invention is to provide a power conversion device for a solar energy generating system, having features of simple structure, low-cost components and excellent economic benefits.

To attain the purposes and effects above, the technical measures adopted by the present invention comprises a direct current-to-direct current converter, a direct current-to-alternating current inverter and at least one relay. The direct current-to-direct current converter comprises a set of converter input ends and a set of converter output ends, wherein the converter input ends is connected to an external solar panel via a set of solar energy power input ends to lead in a direct current outputting from the solar panel and to transform the direct current outputting from the solar panel into a direct voltage with different specifications, and the direct voltage is output by the converter output ends. The direct current-to-alternating current inverter comprises a set of inverter input ends connected to the converter output ends of the direct current-to-direct current converter for transforming the direct voltage into an alternating voltage and a set of inverter output ends connected to an external electric load via a set of electric load output end. The relay comprises a coil being connected to an external commercial power line via a set of commercial power input ends and at least one set of conductive contacts being actuated by the coil and serially disposed between the commercial power input ends and the inverter output ends of the direct current-to-alternating current inverter so as to control an conduction between the commercial power input ends and the inverter output ends of the direct current-to-alternating current inverter.

According to the above structure, wherein the commercial power input ends are respectively connected to a plurality of parallel-arranged coils of the relays, and the conductive contacts of each of the relays are arranged in serial connection.

According to the above structure, the solar panel is further connectively paralleled to a storage battery which is rechargeable by a charging module disposed between the solar panel and the storage battery.

According to the above structure, the converter input end of the direct current-to-direct current converter is disposed with an input end filter which is utilized to filter abnormal electric currents or impulse outputting from the solar panel, and the inverter output end of the direct current-to-alternating current inverter is disposed with an output end filter which is utilized to filter a harmonic wave outputting from the direct current-to-alternating current inverter.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing the basic structure of a conventional paralleled power conversion device with solar energy generation and the application thereof;

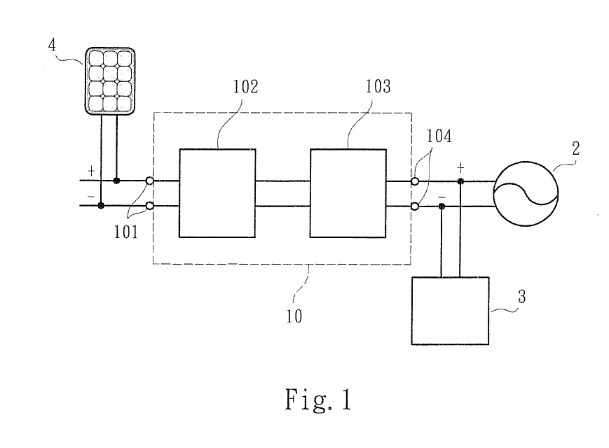

FIG. 2 is a schematic view showing the structure of a conventional paralleled power conversion device capable of preventing an islanding effect and the application thereof;

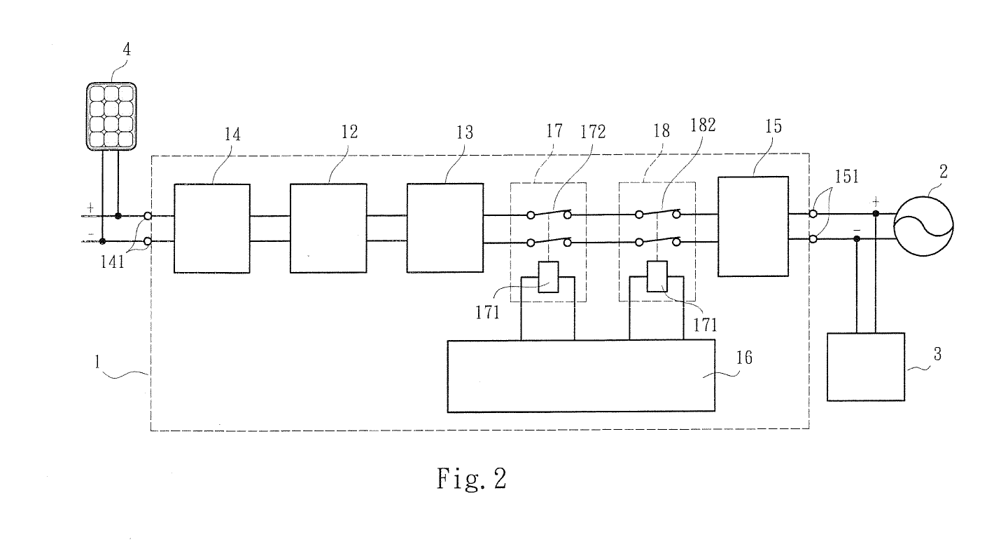

FIG. 3 is a schematic view showing a circuit block of a first embodiment of the present invention and the application thereof; and

FIG. 4 is a schematic view showing a circuit block of a second embodiment of the present invention and the application thereof.

### DETAILED DESCRIPTION OF THE INVENTION

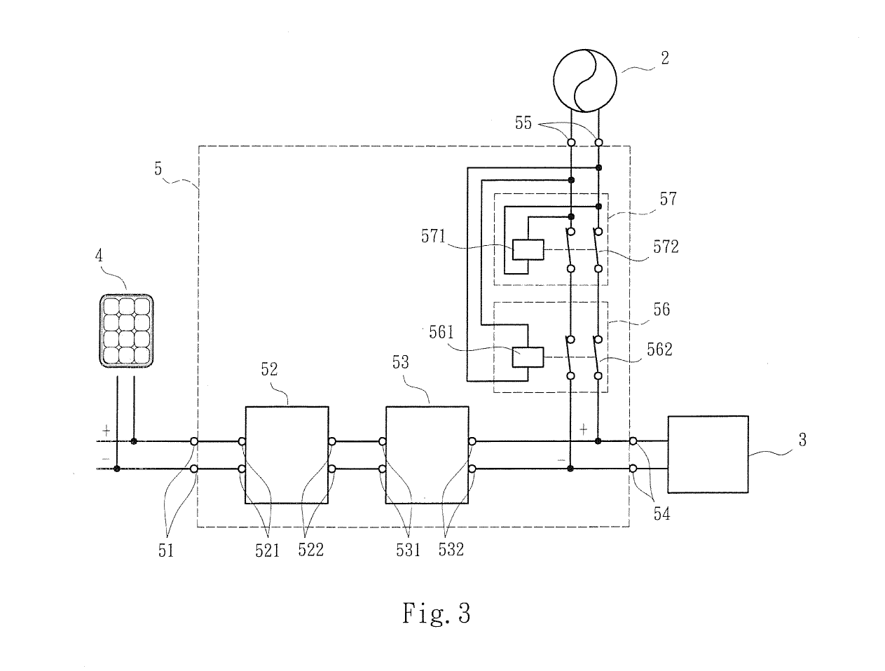

Referring to FIG. 3, an inverter 5 for a solar energy generating system of a first embodiment of the present invention mainly comprises a direct current-to-direct current (DC-DC) converter 52, a direct current-to-alternating current (DC-AC) inverter 53 and two relays 56 and 57. The DC-DC converter 52 comprises a set of converter input ends 521 and a set of converter output ends 522, wherein the converter input ends 521 are connected to an external solar panel 4 (solar energy batteries) via a set of solar energy power input ends 51 to lead in a direct current outputting from the solar panel 4 and to transform the direct current outputting from the solar panel 4 into a direct voltage with different specifications, and the direct voltage is output by the converter output ends 522. The DC-AC inverter 53 comprises a set of inverter input ends 531 and a set of inverter output ends 532, wherein the inverter input ends 531 is connected to the converter output ends 522 of the DC-DC converter 52 for transforming the direct voltage into an alternating voltage, and the inverter output ends 532 is connected to an external electric load 3 via a set of electric load output end 54. The relay 56 comprises a coil 561 and at least one set of conductive contacts 562 actuated by the coil 561, and the relay 57 comprises a coil 571 and at least one set of conductive contacts 572 actuated by the coil 571. The coils 561 and 571 of the relays 56 and 57 are connected to an external commercial power line 2 via a set of commercial power input ends 55, and the conductive contacts 562 and 572 of the relays 56 and 57 are serially disposed between the commercial power input ends 55 and the electric load output end 54. Also, the conductive contacts 562 and 572 of the relays 56 and 57 are serially disposed between the commercial power input ends 55 and the inverter output ends 532 of the direct current-to-alternating current inverter 53 so as to control a conduction between the commercial power input ends 55 and the inverter output ends 532 of the direct current-to-alternating current inverter 53.

In actual applications, when the commercial power line 2 normally supplies power to electrify the coils 561 and 571 of the relays 56 and 57, the conductive contacts 562 and 572 of the relays 56 and 57 are conducted and kept in a normal closed state to normally remain the outputting of the inverter 5 (solar energy power supply system), so that the inverter 5 and the commercial power line 2 can be kept in a normally paralleled state to supply power to the electric load 3. If the power supplied from the commercial power line 2 is interrupted or abnormalities are occurred in the operation process, the coils 561 and 571 of the relays 56 and 57 are electrically interrupted so as to enable the conductive contacts 562 and 572 of the relays 56 and 57 in an open (open-circuit) state, thereby preventing the facilities of the commercial power line 2 from being inversely impacted by the output electric energy of the inverter 5, i.e., preventing the islanding effect from happening. In spite of this, the power supply from the inverter 5 to the electric load 3 still can be maintained normally, and also the convenience and usability in operation are not affected.

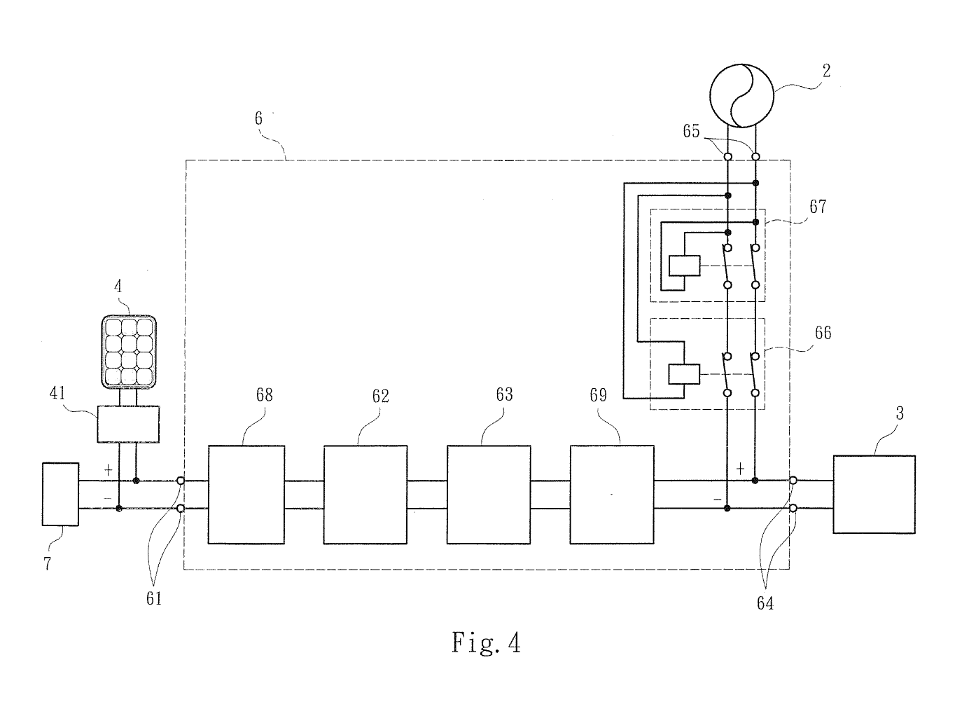

Referring to FIG. 4, an inverter 6 of a second embodiment of the present invention comprises a direct current-to-direct current (DC-DC) converter 62, a direct current-to-alternating current (DC-AC) inverter 63, two relays 66 and 57, a set of solar energy power input ends 61, an electric load output end 64 and a set of commercial power input ends 65, which have the same configuration and connection structure as that of the DC-DC converter 52, the DC-AC inverter 53, the two relays 56 and 57, the solar energy power input ends 51, the electric load output end 54 and the commercial power input ends 55 in the first embodiment. The inverter 6 of the second embodiment differs from the inverter 5 of the first embodiment in that an input end filter 68 and an output end filter 69 are further provided, wherein the input end filter 68 disposed on the converter input end 521 of the direct current-to-direct current converter 52 is provided between the DC-DC converter 62 and the solar energy power input ends 61 to filter abnormal electric currents or impulse outputting from the solar panel 4, and the output end filter 69 disposed between the DC-AC inverter 63 and the electric load output end 64 is utilized to filter a harmonic wave of the output current from the DC-AC inverter 63. Besides, the inverter 6 yet further provide a storage battery 7 which is connectively paralleled to the solar energy power input ends 61 and the solar panel 4, and a charging module 41 which is disposed between the solar panel 4 and the storage battery 7 and capable of controlling the DC voltage outputting from the solar panel 4 to recharge the storage battery 7.

In summary, the inverter improving device for the solar energy generating system of the present invention does effectively prevent the islanding effect from happening, simplify the related configurations and structures and reduce the production cost the related devices. Thus, the present invention is truly a novel and progressive invention. While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A power conversion device for a solar energy generating system, at least comprising:
a direct current-to-direct current converter, comprising a set of converter input ends and a set of converter output ends, the converter input ends being connected to an external solar panel via a set of solar energy power input ends to lead in a direct current outputting from the solar panel and to transform the direct current outputting from the solar panel into a direct voltage with different specifications, the direct voltage being output by the converter output ends;
a direct current-to-alternating current inverter, comprising a set of inverter input ends connected to the converter output ends of the direct current-to-direct current converter for transforming the direct voltage into an alternating voltage and a set of inverter output ends connected to an external electric load via a set of electric load output end; and
at least one relay, comprising a coil being connected to an external commercial power line via a set of commercial power input ends and at least one set of conductive contacts being actuated by the coil and serially disposed between the commercial power input ends and the inverter output ends of the direct current-to-alternating current inverter so as to control an conduction between the commercial power input ends and the inverter output ends of the direct current-to-alternating current inverter.

2. The power conversion device for the solar energy generating system as claimed in claim 1, wherein the commercial power input ends are respectively connected to a plurality of parallel-arranged coils of the relays, and the conductive contacts of each of the relays are arranged in serial connection.

3. The power conversion device for the solar energy generating system as claimed in claim 1, wherein the solar panel is further connectively paralleled to a storage battery which is rechargeable by a charging module disposed between the solar panel and the storage battery.

4. The power conversion device for the solar energy generating system as claimed in claim 2, wherein the solar panel is further connectively paralleled to a storage battery which is rechargeable by a charging module disposed between the solar panel and the storage battery.

5. The power conversion device for the solar energy generating system as claimed in claim 1, wherein the converter input end of the direct current-to-direct current converter is disposed with an input end filter which is utilized to filter an abnormal electric current or impulse outputting from the solar panel.

6. The power conversion device for the solar energy generating system as claimed in claim 2, wherein the converter input end of the direct current-to-direct current converter is disposed with an input end filter which is utilized to filter an abnormal electric current or impulse outputting from the solar panel.

7. The power conversion device for the solar energy generating system as claimed in claim 3, wherein the converter input end of the direct current-to-direct current converter is disposed with an input end filter which is utilized to filter an abnormal electric current or impulse outputting from the solar panel.

8. The power conversion device for the solar energy generating system as claimed in claim 4, wherein the converter input end of the direct current-to-direct current converter is disposed with an input end filter which is utilized to filter an abnormal electric current or impulse outputting from the solar panel.

9. The power conversion device for the solar energy generating system as claimed in claim 1, wherein the inverter output end of the direct current-to-alternating current inverter is disposed with an output end filter which is utilized to filter a harmonic wave outputting from the direct current-to-alternating current inverter.

10. The power conversion device for the solar energy generating system as claimed in claim 2, wherein the inverter output end of the direct current-to-alternating current inverter is disposed with an output end filter which is utilized to filter a harmonic wave outputting from the direct current-to-alternating current inverter.

11. The power conversion device for the solar energy generating system as claimed in claim 3, wherein the inverter output end of the direct current-to-alternating current inverter is disposed with an output end filter which is utilized to filter a harmonic wave outputting from the direct current-to-alternating current inverter.

12. The power conversion device for the solar energy generating system as claimed in claim 4, wherein the inverter output end of the direct current-to-alternating current inverter is disposed with an output end filter which is utilized to filter a harmonic wave outputting from the direct current-to-alternating current inverter.

13. The power conversion device for the solar energy generating system as claimed in claim 5, wherein the inverter output end of the direct current-to-alternating current inverter is disposed with an output end filter which is utilized to filter a harmonic wave outputting from the direct current-to-alternating current inverter.

14. The power conversion device for the solar energy generating system as claimed in claim 6, wherein the inverter output end of the direct current-to-alternating current inverter is disposed with an output end filter which is utilized to filter a harmonic wave outputting from the direct current-to-alternating current inverter.

15. The power conversion device for the solar energy generating system as claimed in claim 7, wherein the inverter output end of the direct current-to-alternating current inverter is disposed with an output end filter which is utilized to filter a harmonic wave outputting from the direct current-to-alternating current inverter.

16. The power conversion device for the solar energy generating system as claimed in claim 8, wherein the inverter output end of the direct current-to-alternating current inverter is disposed with an output end filter which is utilized to filter a
